(19) United States
(12) Patent Application Publication
(10) Pub. No.: US 2014/0250251 A1
(43) Pub. Date: Sep. 4, 2014

(54) AUTOMATICALLY AND TRANSPARENTLY PRESERVING TESTING STATE ACROSS SESSIONS

(71) Applicant: Apple Inc., Cupertino, CA (US)

(72) Inventor: Paul Marks, San Jose, CA (US)

(73) Assignee: Apple Inc., Cupertino, CA (US)

(21) Appl. No.: 14/191,102

(22) Filed: Feb. 26, 2014

Related U.S. Application Data
(60) Provisional application No. 61/771,733, filed on Mar. 1, 2013.

(51) Int. Cl. G06F 9/445; G06F 13/24

(52) U.S. Cl. CPC G06F 9/445; G06F 13/24
USPC 710/267

(57) ABSTRACT

Disclosed is a technique for an automated testing harness that transparently preserves testing state across system sessions. The testing harness can be configured to execute a script of testing instructions, one or more of which can trigger a change in a system session. Prior to performing the session change, the testing harness can save test state and suspend the test. Upon resuming the test, the test harness can overwrite the initial values with the saved state values. To enable the automated testing, the testing harness can include a launch daemon and one or more launch agents. Upon a session change, an active launch agent can notify a launch daemon of its active status. This can cause the launch daemon to resume the test and restore the test state to the saved values.

### CROSS REFERENCE TO RELATED APPLICATIONS

This application claims the benefit of U.S. Provisional Patent Application No. 61/771,733, entitled “AUTOMATICALLY AND TRANSPARENTLY PRESERVING TESTING STATE ACROSS SESSIONS,” filed on Mar. 1, 2013, which is incorporated herein by reference in its entirety.

### TECHNICAL FIELD

The present technology pertains to executing a test application, and more specifically pertains to executing a test application in an automated testing harness that transparently preserves testing state across session changes.

### BACKGROUND

Application testing is a crucial step in the software development process. An application can be put through a series of tests, often using a testing harness, in an attempt to exercise the many different code paths and features in an application. Only after extensive testing are applications generally made available for use. Some applications are very easy to test because they require minimal input and do not interact with system resources outside of the resources necessary to execute an application. However, other applications, such as operating systems, require exercising features that cause a change in the system session and can terminate any active applications. For example, one feature that should be tested when testing an operating system application is the reboot feature. However, when the operating system reboots, all active applications are terminated before the system is shut down. Even if the operating system is configured to restart an application, the state of the application prior to the reboot may not be saved. The same is true when switching from one user session to another. Without the ability to maintain state and resume the test, testing features that require session changes is difficult to automate.

### SUMMARY

Additional features and advantages of the disclosure will be set forth in the description which follows, and in part will be obvious from the description, or can be learned by practice of the herein disclosed principles. The features and advantages of the disclosure can be realized and obtained by means of the instruments and combinations particularly pointed out in the appended claims. These and other features of the disclosure will become more fully apparent from the following description and appended claims, or can be learned by the practice of the principles set forth herein.

Disclosed are systems, methods, and non-transitory computer-readable storage media for automatically and transparently preserving testing state across session changes. The automatic preservation of testing state can enable automated testing of applications that perform session changing actions, such as a system reboot or a user session switch. By saving the testing state, the session changing action can automatically be performed and the test can resume using the saved state.

The disclosed technology can be used to create a testing harness for testing applications. The testing harness can include a test coordinator, which can detect active sessions and coordinate the execution of a test in a session. In some cases, the test coordinator can include a launch daemon and one or more launch agents. The launch daemon can be a system service that is always running and acts as a coordinator for the testing harness. Each launch agent can be linked to a particular user session and include monitoring functionality to determine whether the associated session is currently active. Additionally, a launch agent can notify the launch daemon for coordination of test execution. During the execution of a test application, the testing harness can determine whether an instruction in the test application is a session change triggering instruction. When a session change triggering instruction is detected, the testing harness can save the current state of the test application and suspend the test.

The testing state can include the current values of variables in the test application. The testing harness can automatically select which variables will be saved. A way to perform the automatic selection can be based on coding conventions. For example, the testing harness can be configured to save the state of all variables named using all capital letters.

After the test application is suspended, the system can perform a session changing action triggered by the session change instruction in the test application. For example, the system can reboot or change to a different user session. At some point after performing the session changing action, a launch agent can detect that a session is active and notify the launch daemon. In response to the notification from the launch agent, the launch daemon can resume a suspended test. This can include retrieving the saved state for the test and restoring the test application to the saved state by overwriting initial values in the test application with a corresponding value from the saved state. Execution of the resumed test can begin at a default re-entry point or other specified location, such as a function associated with the session change action.

### BRIEF DESCRIPTION OF THE DRAWINGS

In order to describe the manner in which the above-recited and other advantages and features of the disclosure can be obtained, a more particular description of the principles briefly described above will be rendered by reference to specific embodiments thereof which are illustrated in the appended drawings. Understanding that these drawings depict only exemplary embodiments of the disclosure and are not therefore to be considered to be limiting of its scope, the principles herein are described and explained with additional specificity and detail through the use of the accompanying drawings in which:

FIG. 1 illustrates an exemplary test application;

FIG. 2 illustrates an exemplary device configured for automated testing that preserves testing state;

FIG. 3 illustrates an exemplary session change scenario;

FIG. 4 illustrates an exemplary test application execution in a testing harness that automatically preserves testing state;

FIG. 5 illustrates an exemplary method embodiment for transparently preserving state across session changes; and

FIG. 6A and FIB. 6B illustrate exemplary system embodiments.

### DESCRIPTION

Various embodiments of the disclosure are discussed in detail below. While specific implementations are discussed, it should be understood that this is done for illustration purposes only. A person skilled in the relevant art will recognize that other components and configurations may be used without parting from the spirit and scope of the disclosure.

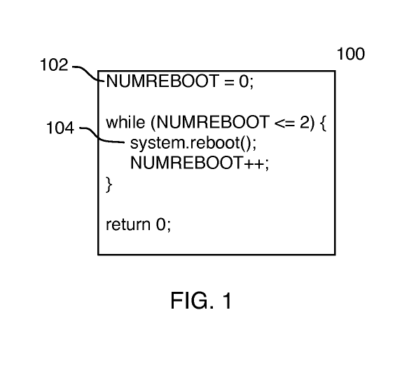

The disclosed technology addresses the need in the art for a testing harness that can automatically preserve testing state across session changes, such as a system reboot or user session change. The testing harness can execute test applications that include variables and instructions. For example, FIG. 1 illustrates exemplary test application 100 that exercises the system reboot feature. A test application can include one or more variables, such as variable 102: NUMREBOOT, and a sequence of test instructions. The sequence of test instructions can include one or more session changing instructions that can trigger a session change, such as instruction 104. Prior to executing the session changing instruction, the testing harness can save the current state of the test and suspend it.

The testing state can include the current values of variables in the test application. A feature of the disclosed technology is the ability to automatically preserve testing state. In addition to automatically saving the current state of one or more variables, the testing harness can automatically select which variables will be saved. A way to perform the automatic selection can be based on coding conventions. For example, the testing harness can be configured to save the state of all variables named using all capital letters. This can be based on the assumptions that the developer followed a coding convention that such variables are global variables, and that the state of global variables is necessary for accurate testing across sessions. For example, variable 102 can be selected for automatic saving of variable state since it named using all capital letters. In addition to automatic selection based on coding conventions other techniques for identifying variables can be used, such as user supplied annotations or command line parameters specifying variables.

Upon resuming the test, the testing harness can overwrite the initial values for the saved variables with the saved state values. For example, if the testing harness saved the state of variable 102 as 1, upon resuming the testing harness can overwrite the initial value of 0 with the saved value of 1.

The testing harness can resume the test at a specified location or entry point, which can be a predefined entry point or a location specified by the test. For example, if the test was suspended at a system.reboot( ) instruction, the test could specify a function in the system.reboot( ) call at which to resume. Alternatively, in some embodiments, the saved state can include the currently executing instruction.

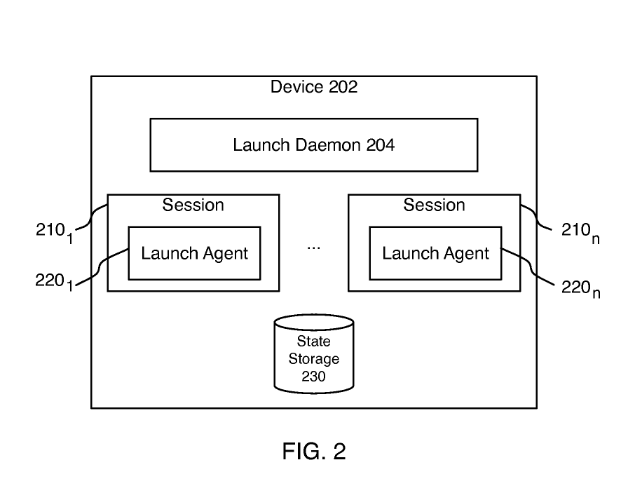

To enable automatic testing state preservation the testing harness can include a test coordinator, which can detect active sessions and coordinate the execution of a test in a session. In some embodiments, the test coordinator can include a launch daemon and one or more launch agents. The launch daemon can be a system service that is always running and acts as a coordinator for the testing harness. Each launch agent can be linked to a particular user session and include monitoring functionality to determine whether the associated session is currently active. Additionally, a launch agent can notify the launch daemon for coordination of test execution. For example, FIG. 2 illustrates exemplary device 202. The device 202 can be any computing device capable of executing the testing harness and saving state such as a server, desktop computer, mobile computer, handheld communications device, e.g. mobile phone, smart phone, tablet; and/or any other computing device.

Device 202 can include launch daemon 204 and can be capable of supporting a variety of different sessions 210₁, . . . , 210ₙ. Sessions 210₁, . . . , 210ₙ can each have a launch agent 220₁, . . . , 220ₙ, respectively. In some cases, a first session and a second session can be sessions associated with a same user account, but the second session is instantiated after a reboot. A first session and a second session can also be sessions associated with different user accounts, such as after a user session change.

Upon detecting a test application instruction that can trigger a session change, such as a system reboot, user session switch, or system sleep, the testing harness can save the testing state to a storage location, such as state storage 230. State storage 230 can be local or remote storage, such as a local or remote hard drive. However, in order to preserve state across different user sessions, e.g. user accounts, state storage 230 must be accessible to the different user sessions. Additionally, the saved data must be readable and writeable by the testing harness during the different sessions. A way to accomplish this is to save the data as globally readable and writeable.

The testing state can include the current values of variables in the test application. After saving the testing state, the test application can be suspended and the session changing action can be performed.

Upon a session activation, such as a reboot, user session switch, or resumption from sleep, a launch agent for the session can notify the launch daemon of its active status. Once the launch daemon receives the active session notification, the launch daemon can resume the test application at a known location or entry point and the testing harness can restore the testing state to the saved state.

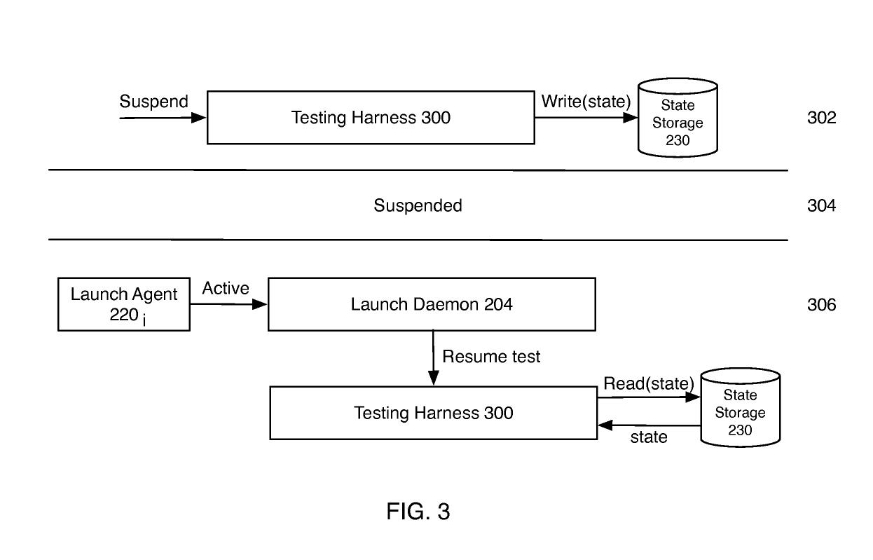

FIG. 3 illustrates communication between the various modules of the testing harness during an exemplary session change scenario. During session 302, testing harness 300 receives a suspend notification, which can be triggered by a session change instruction in a test application currently executing in the testing harness. In response to receiving the suspend notification, testing harness 300 can save the current testing state to state storage 230. Execution of the testing harness can then enter suspended state 304, where a session changing action is occurring. For example, during suspended state 304 device 202 can be rebooting or switching from one user session to another. Upon resuming from suspended state 304, launch agent 220, that is linked to the currently active session can notify launch daemon 204 that session 306 is active. Launch daemon 204 can resume the suspended test application and testing harness 300 can read the saved state from state storage 230.

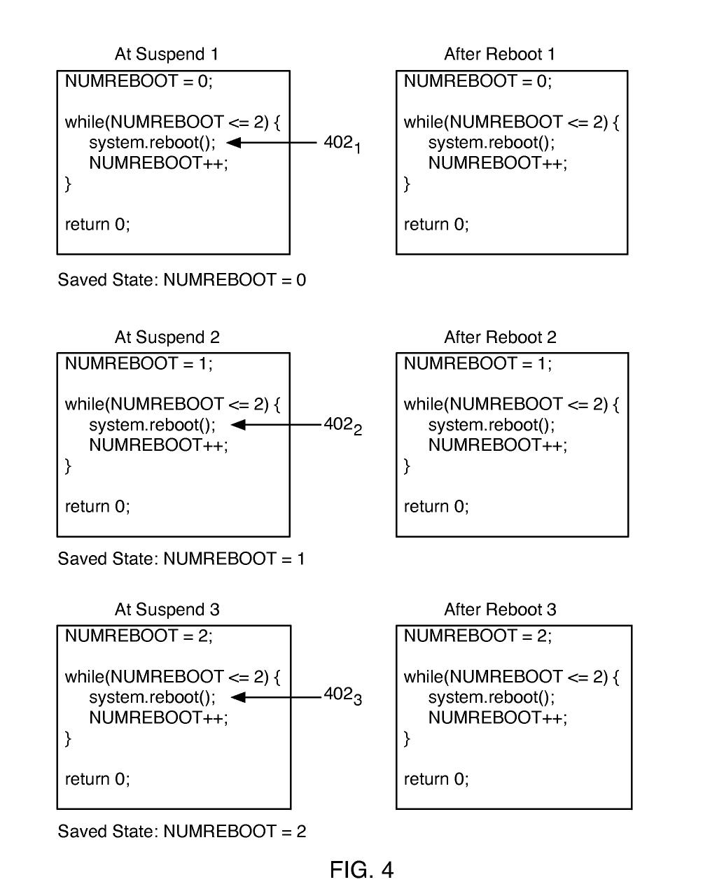

FIG. 4 illustrates an exemplary execution of test application 100 using a testing harness configured with automatic preservation of testing state. The testing harness will begin by executing test application 100 until execution reaches session changing instruction 402₁. At this point, the testing harness will save the current state, e.g. NUMREBOOT=0, and suspend the test. After the test is suspended, the session changing action triggered by session changing instruction 402₁ is performed, in this case a system reboot. Upon resuming from the reboot, the testing harness will read the saved state and overwrite the state in test application 100. In this case, the variable NUMREBOOT had not changed from the initial value so over writing the initial state resulted in no change. The testing harness will then resume execution of test application 100 at a known location or entry point.

The testing harness will continue executing test application 100 until execution reaches a session changing instruction or the end of the test. In this example, the testing harness reaches session changing instruction 402₂. At this point, the testing harness will save the current state, e.g. NUMREBOOT=1, and suspend the test. After the test is suspended, the session changing action triggered by session changing instruction 402₂ is performed, in this case a system reboot. Upon resuming from the reboot, the testing harness will read the saved state and overwrite the state in test application 100. In this case, the variable NUMREBOOT has a saved state of 1 so the value of NUMREBOOT in test application is updated to 1. The testing harness will then resume execution of test application 100 at a known location or entry point.

The testing harness will continue executing test application 100 until execution reaches a session changing instruction or the end of the test. In this example, the testing harness reaches session changing instruction 402₃. At this point, the testing harness will save the current state, e.g. NUMREBOOT=2, and suspend the test. After the test is suspended, the session changing action triggered by session changing instruction 402₃ is performed, in this case a system reboot. Upon resuming from the reboot, the testing harness will read the saved state and overwrite the state in test application 100. In this case, the variable NUMREBOOT has a saved state of 2 so the value of NUMREBOOT in test application is updated to 2. The testing harness will then resume execution of test application 100 at a known location or entry point.

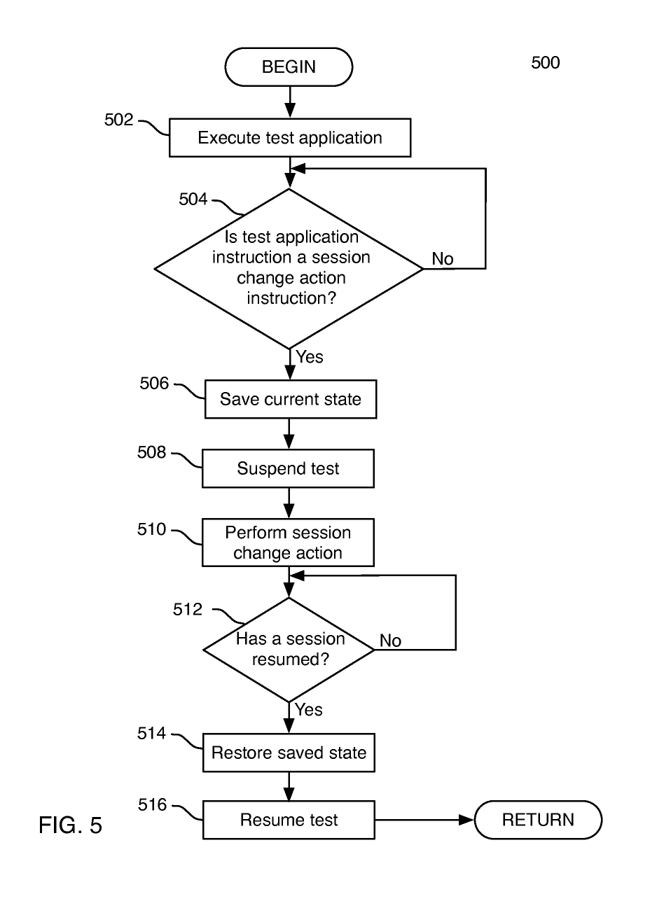

FIG. 5 is a flowchart illustrating an exemplary method 500 for automatically preserving testing state across sessions. For the sake of clarity, this method is discussed in terms of an exemplary system such as is shown in FIG. 2. Although specific steps are shown in FIG. 5, in other embodiments a method can have more or less steps than shown.

The automatic preservation of testing state across sessions can begin when the testing harness running in a first session executes a test application (502). The test application can include a sequence of instructions and a set of variables. As the testing harness executes the instructions, the testing harness can check if the current instruction is a session change triggering instruction (504). If it is not, the testing harness can continue with the next instruction in the test application.

If the instruction is a session change triggering instruction, the testing harness can save the current state (506). The testing state can include the current values of variables in the test application as well as the currently executing instruction. The testing harness can automatically select the variables to save based on a predefined heuristic, such as a coding convention. For example, the testing harness can be configured to save all variables named using all capital letters. The testing harness can also be configured to save variables specified by the developer, such as through annotations or command line parameters. Once the state has been saved, the testing harness can suspend the test (508) and device 202 can perform the session changing action triggered by the session changing instruction in the test application (510). For example, the system can reboot or switch to a different user session.

At some point the session changing action can complete, and launch agent 220, for a session, such as a second session, can check if a session has resumed (512). If the session has resumed, launch agent 220, can notify launch daemon 204 that the session is active. Launch daemon 204 can coordinate the resumption of the suspended test and the test harness can restore the saved data (514) by overwriting the initial values in the test application and resume the suspended test (516). After completing step 516, device 202 can resume previous processing, which can include repeating method 500.

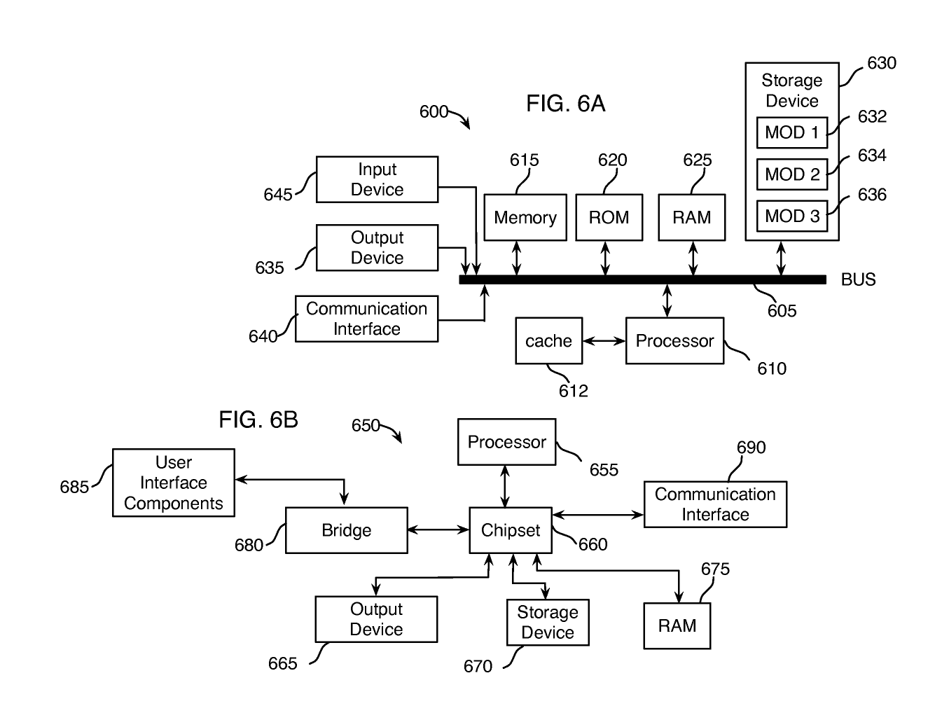

FIG. 6A and FIG. 6B illustrate exemplary possible system embodiments. The more appropriate embodiment will be apparent to those of ordinary skill in the art when practicing the present technology. Persons of ordinary skill in the art will also readily appreciate that other system embodiments are possible.

FIG. 6A illustrates a conventional system bus computing system architecture 600 wherein the components of the system are in electrical communication with each other using a bus 605. Exemplary system 600 includes a processing unit (CPU or processor) 610 and a system bus 605 that couples various system components including the system memory 615, such as read only memory (ROM) 620 and random access memory (RAM) 625, to the processor 610. The system 600 can include a cache of high-speed memory connected directly with, in close proximity to, or integrated as part of the processor 610. The system 600 can copy data from the memory 615 and/or the storage device 630 to the cache 612 for quick access by the processor 610. In this way, the cache can provide a performance boost that avoids processor 610 delays while waiting for data. These and other modules can control or be configured to control the processor 610 to perform various actions. Other system memory 615 may be available for use as well. The memory 615 can include multiple different types of memory with different performance characteristics. The processor 610 can include any general purpose processor and a hardware module or software module, such as module 1 632, module 2 634, and module 3 636 stored in storage device 630, configured to control the processor 610 as well as a special-purpose processor where software instructions are incorporated into the actual processor design. The processor 610 may essentially be a completely self-contained computing system, containing multiple cores or processors, a bus, memory controller, cache, etc. A multi-core processor may be symmetric or asymmetric.

To enable user interaction with the computing device 600, an input device 645 can represent any number of input mechanisms, such as a microphone for speech, a touch-sensitive screen for gesture or graphical input, keyboard, mouse, motion input, speech and so forth. An output device 635 can also be one or more of a number of output mechanisms known to those of skill in the art. In some instances, multimodal systems can enable a user to provide multiple types of input to communicate with the computing device 600. The communications interface 640 can generally govern and manage the user input and system output. There is no restriction on operating on any particular hardware arrangement and therefore the basic features here may easily be substituted for improved hardware or firmware arrangements as they are developed.

Storage device 630 is a non-volatile memory and can be a hard disk or other types of computer readable media which can store data that are accessible by a computer, such as magnetic cassettes, flash memory cards, solid state memory devices, digital versatile disks, cartridges, random access memories (RAMs) 625, read only memory (ROM) 620, and hybrids thereof.

The storage device 630 can include software modules 632, 634, 636 for controlling the processor 610. Other hardware or software modules are contemplated. The storage device 630 can be connected to the system bus 605. In one aspect, a hardware module that performs a particular function can include the software component stored in a computer-readable medium in connection with the necessary hardware components, such as the processor 610, bus 605, display 635, and so forth, to carry out the function.

FIG. 6B illustrates a computer system 650 having a chipset architecture that can be used in executing the described method and generating and displaying a graphical user interface (GUI). Computer system 650 is an example of computer hardware, software, and firmware that can be used to implement the disclosed technology. System 650 can include a processor 655, representative of any number of physically and/or logically distinct resources capable of executing software, firmware, and hardware configured to perform identified computations. Processor 655 can communicate with a chipset 660 that can control input to and output from processor 655. In this example, chipset 660 outputs information to output 665, such as a display, and can read and write information to storage device 670, which can include magnetic media, and solid state media, for example. Chipset 660 can also read data from and write data to RAM 675. A bridge 680 for interfacing with a variety of user interface components 685 can be provided for interfacing with chipset 660. Such user interface components 685 can include a keyboard, a microphone, touch detection and processing circuitry, a pointing device, such as a mouse, and so on. In general, inputs to system 650 can come from any of a variety of sources, machine generated and/or human generated.

Chipset 660 can also interface with one or more communication interfaces 690 that can have different physical interfaces. Such communication interfaces can include interfaces for wired and wireless local area networks, for broadband wireless networks, as well as personal area networks. Some applications of the methods for generating, displaying, and using the GUI disclosed herein can include receiving ordered datasets over the physical interface or be generated by the machine itself by processor 655 analyzing data stored in storage 670 or 675. Further, the machine can receive inputs from a user via user interface components 685 and execute appropriate functions, such as browsing functions by interpreting these inputs using processor 655.

It can be appreciated that exemplary systems 600 and 650 can have more than one processor 610 or be part of a group or cluster of computing devices networked together to provide greater processing capability.

For clarity of explanation, in some instances the present technology may be presented as including individual functional blocks including functional blocks comprising devices, device components, steps or routines in a method embodied in software, or combinations of hardware and software.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, flash memory, USB devices provided with non-volatile memory, networked storage devices, and so on.

Devices implementing methods according to these disclosures can comprise hardware, firmware and/or software, and can take any of a variety of form factors. Typical examples of such form factors include laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

1. A computer-implemented method comprising:
detecting a session change action during execution of a test application in a first session, the test application including a sequence of instructions and a set of variables;
saving state associated with the test application and suspending the test application, the suspending causing an exit from the first session;
detecting a resumption from the suspend action, the resumption causing an activation of a second session;
resuming the test application and restoring the saved state associated with the test application, wherein restoring the saved state includes overwriting at least one initial value in the test application with a corresponding value from the saved state.

2. The computer-implemented method of claim 1, wherein the session change action includes at least one of a system reboot, a user session switch, or a system sleep.

3. The computer-implemented method of claim 1, wherein detecting a session change action further comprises:
executing a session change action instruction from the sequence of instructions.

4. The computer-implemented method of claim 1, wherein saving the state further comprises:
automatically selecting at least one variable from the set of variables based on coding convention.

5. The computer-implemented method of claim 1, wherein detecting the resumption from the suspend action further comprises:
receiving a notification at a launch daemon from a launch agent, the launch agent linked to the second session.

6. The computer-implemented method of claim 1, wherein the saved state is stored in a file readable and writeable in the first session and the second session.

7. A system comprising:
a processor;
a computer readable storage medium;
a launch daemon configured to control the processor to:
detect a session change triggering instruction during execution of an application in a first session, the application including a sequence of instructions and a set of variables; and
in response to detecting the session change triggering instruction, save application state to the computer readable storage medium and suspend execution of the application, the suspending causing an exit from the first session;
a launch agent configured to control the processor to:
detect a resumption from the suspend action, the resumption causing an activation of a second session; and
notify the launch daemon, the notifying causing the launch daemon to resume execution of the application;
a testing harness configured to control the processor to:
restore the saved application state, wherein restoring the saved application state includes reading the saved application state from the computer readable storage medium and overwriting at least one initial value in the set of variables with a corresponding value from the saved application state.

8. The system of claim 7, wherein execution of the application can begin at a default re-entry point in the application.

9. The system of claim 8, wherein a default re-entry point is a function associated with the session change triggering instruction.

10. The system of claim 7, wherein execution of the application can begin at an instruction specified in the saved application state.

11. The system of claim 7, wherein saving the state further comprises:
automatically selecting at least one variable from the set of variables based on coding convention.

12. The system of claim 7, wherein saving the state further comprises:
automatically saving a current value for each global variable in the set of variables.

13. The system of claim 12, wherein a global variable is identified as a variable in the set of variables named using all capital letters.

14. The system of claim 7, wherein saving the state further comprises:
automatically selecting at least one variable from the set of variables based on an annotation attached to the at least one variable.

15. A manufacture comprising:
a non-transitory computer-readable storage medium; and
a computer executable instruction stored on the non-transitory computer-readable storage medium which, when executed by a computing device, cause the computing device to perform a method comprising:
detecting a session change action during execution of an application in a first session, the application including a sequence of instructions and a set of variables;
saving application state and suspending the application, the suspending causing an exit from the first session;
detecting a resumption from the suspend action, the resumption causing an activation of a second session;
resuming the application in the second session and restoring the saved application state, wherein restoring the saved application state includes overwriting at least one initial value in the application with a corresponding value from the saved application state.

16. The manufacture of claim 15, wherein the session change action includes at least one of a system reboot, a user session switch, or a system sleep.

17. The manufacture of claim 15, wherein detecting a session change action further comprises:
executing a session change action instruction from the sequence of instructions.

18. The manufacture of claim 15, wherein saving the application state further comprises:
automatically selecting at least one variable from the set of variables based on coding convention.

19. The manufacture of claim 15, wherein detecting the resumption from the suspend action further comprises:
receiving a notification at a launch daemon from a launch agent, the launch agent linked to the second session.

20. The manufacture of claim 15, wherein the saved application state is stored in a file readable and writeable in the first session and the second session.
